(19) United States
(12) Patent Application Publication
(10) Pub. No.: US 2017/0147679 A1
(43) Pub. Date: May 25, 2017

(54) QUERY EXPANSION SYSTEM AND METHOD USING LANGUAGE AND LANGUAGE VARIANTS

(71) Applicant: QATAR FOUNDATION, Doha (QA)

(72) Inventor: Ahmed ABDELALI, Doha (QA)

(21) Appl. No.: 15/117,107

(22) PCT Filed: Feb. 6, 2014
(86) PCT No.: PCT/EP2014/052356

§ 371 Date: Aug. 5, 2016

(51) Int. Cl. G06F 17/30

(52) U.S. Cl. CPC G06F 17/30672; G06F 17/30867; G06F 17/30613

(57) ABSTRACT

A system comprising: a term retrieval module configured to receive a search query including a search term and to output an expanded search query including the search terms and an additional search terms; a search engine sub-system configured to receive the expanded search query and to output one or more search results based on the expanded search query, the one or more search results indicating one or more information resources of relevance to the expanded search query, wherein the system further comprises: a classification module configured to determine a language or language variant of the search term of the search query, identify the additional search term based on the language or language variant of the search term, and output the additional search term to the term retrieval module

Embodiments of the present invention relate to a system and method involving a search engine module using language and language variants.

Search engines are used to identify information of potential interest to a user. The user enters a search query into the search engine (the search query comprising one or more search terms), and the query is compared to an index to which the search engine has access. Entries in the index are associated with identifiers for information resources covered by the search engine. The comparison of the query to the index, therefore, provides the search engine with identifiers for information resources which are associated with the entered search query. The search engine is typically configured to provide the information resources and/or the identifiers to the user as a set of search results.

Such search engines are commonly used to search large volumes of information, such as the World Wide Web and other internet resources. Search engines of this type may also be used in relation to libraries and other archives.

The relevance of the search results to the search query depends, substantially, on the content of that search query (i.e. the terms used in the search query).

There are many reasons why the search query may provide less than ideal search results. For example, there are often many synonymous terms. Which term is used in a particular information resource and which term is used in a particular search query depends on one or more characteristics of the creator of the information resource and the user, respectively. The characteristics may include, for example, the language, location, educational background, age, and the like.

In some instances, a single term used in a search query may be common to the user and the information resources. However, that term may have a different meaning in the information resources to that intended by the user. Such instances are common in relation to languages with a plurality of regional variants—such as Arabic and English. For example, the term “pavement” in British English is equivalent to the term “sidewalk” in American English but “pavement” in American English is equivalent to “road surface” in British English. Thus, a search query using the term “pavement” will result in the identification of British English information resources and American English resources which are concerned with different parts of a road or street.

Accordingly, a search query using a particular term which is not used consistently in all of the information resources covered by the search engine, will not be sufficient for the search engine to identify all of the relevant information resources and/or information resource which are all relevant.

Aspects of the present invention seek to ameliorate one or more problems associated with the prior art.

A first aspect of the present invention provides, a system comprising: a term retrieval module configured to receive a search query including a search term and to output an expanded search query including the search terms and an additional search terms; and a search engine sub-system configured to receive the expanded search query and to output one or more search results based on the expanded search query, the one or more search results indicating one or more information resources of relevance to the expanded search query, wherein the system further comprises: a classification module configured to determine a language or language variant of the search term of the search query, identify the additional search term based on the language or language variant of the search term, and output the additional search term to the term retrieval module.

The classification module may be configured to identify the additional search term from a term which is semantically related to the search term within the context of the language or language variant of the search term.

The search engine sub-system may be configured to output one or more search results indicating one or more information resources of relevance to the expanded search query, the information resources being in a language or language variant of the search term.

The search ending sub-system may comprise: a search engine module configured to receive the expanded search query; an index module including an index of information resources; and a retrieval module communicatively coupled to the search engine module and the index module and operable to access at least a portion of the index of the index module to identify one or more search results.

The index module may be configured to access at least a portion of the index based on the language or language variant of the search term.

The classification module may be configured to identify the additional search term from a term which is synonymous with the search term in a language or language variant different to the language or language variant of the search term.

The search ending sub-system may comprise: a search engine module configured to receive the expanded search query; an index module including an index of information resources; and a retrieval module communicatively coupled to the search engine module and the index module and operable to access at least a portion of the index of the index module to identify one or more search results, the portion of the index being determined by the language or language variant of the search term and the language or language variant of the additional search term.

The system may further comprise an index generation module which is configured to generate an index of information resources for use in determining the one or more search results, wherein the index generation module is coupled to the classification module such that the index generation module is further configured to classify the index based on a language or language variant of each information resource determined by the classification module.

The system may further comprise a module to present an interface to a user, wherein the interface is configured to present one or more user selectable options for the language or language variant of the search query and/or the additional search term.

The user selectable option for the additional search term may comprise a plurality of possible additional search terms identified by the classification module.

The language or language variants may include regional language variants.

The regional language variants may include variants of Arabic.

The regional language variants may include variants of English.

Another aspect provides, a computer implemented method comprising: receiving a search query including a search term at a term retrieval module; outputting, from the term retrieval module, an expanded search query including the search terms and an additional search terms; receiving the expanded search query at a search engine sub-system; outputting, from the search engine sub-system, one or more search results based on the expanded search query, the one or more search results indicating one or more information resources of relevance to the expanded search query; and determining, using a classification module, a language or language variant of the search term of the search query, identifying the additional search term based on the language or language variant of the search term, and outputting the additional search term to the term retrieval module.

The method may further comprise: identifying, using the classification module, the additional search term from a term which is semantically related to the search term within the context of the language or language variant of the search term.

The outputting one or more search results indicating one or more information resources of relevance to the expanded search query, may comprise outputting search results indicating one or more information resources in a language or language variant of the search term.

The method may further comprise: receiving the expanded search query in a search engine module; providing an index module including an index of information resources; providing a retrieval module communicatively coupled to the search engine module and the index module; and accessing at least a portion of the index of the index module to identify one or more search results.

Accessing at least a portion of the index may be based on the language or language variant of the search term.

The method may further comprise: identifying, using the classification module, the additional search term from a term which is synonymous with the search term in a language or language variant different to the language or language variant of the search term.

The method may further comprise: receiving the expanded search query in a search engine module; providing an index module including an index of information resources; providing a retrieval module communicatively coupled to the search engine module and the index module; and accessing at least a portion of the index of the index module to identify one or more search results, the portion of the index being determined by the language or language variant of the search term and the language or language variant of the additional search term.

The method may further comprise: generating, in an index generation module, an index of information resources for use in determining the one or more search results, wherein the index generation module is coupled to the classification module; and classifying, using the index generation module, the index based on a language or language variant of each information resource determined by the classification module.

The method may further comprise: presenting an interface to a user, wherein the interface is configured to present one or more user selectable options for the language or language variant of the search query and/or the additional search term.

The user selectable option for the additional search term may comprise a plurality of possible additional search terms identified by the classification module.

The language or language variants may include regional language variants.

The regional language variants may include variants of Arabic.

The regional language variants may include variants of English.

Embodiments of the present invention are described, by way of example, with reference to the accompanying drawings, in which:

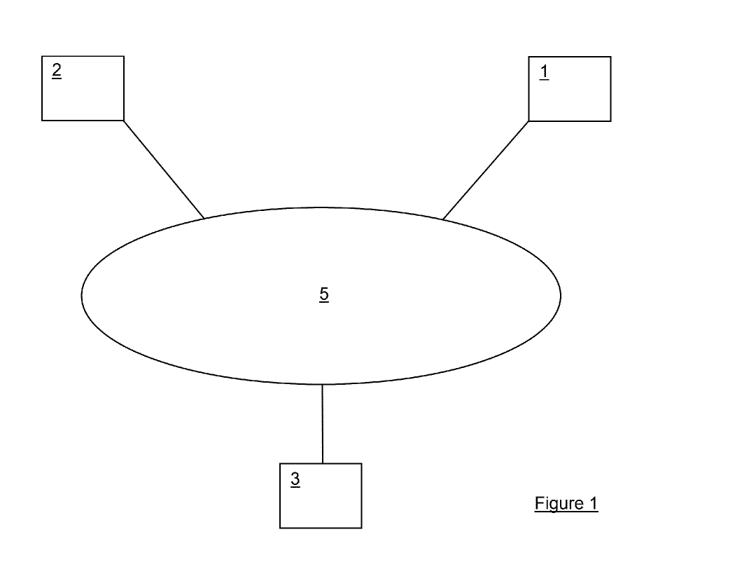

FIG. 1 shows a schematic diagram of an embodiment;

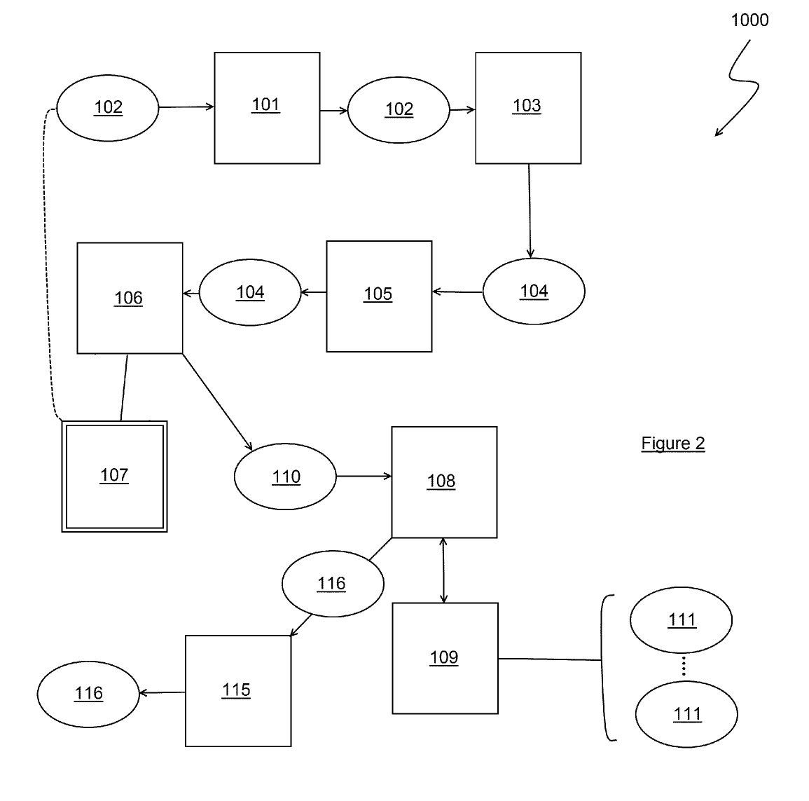

FIG. 2 shows a schematic diagram of an embodiment of a system;

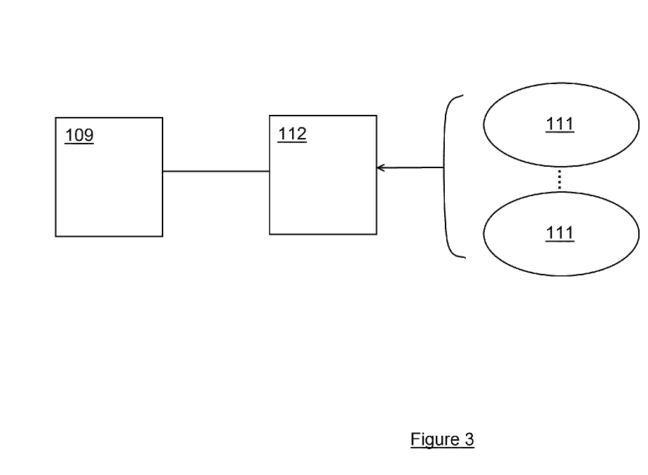

FIG. 3 shows a schematic diagram of part of an embodiment;

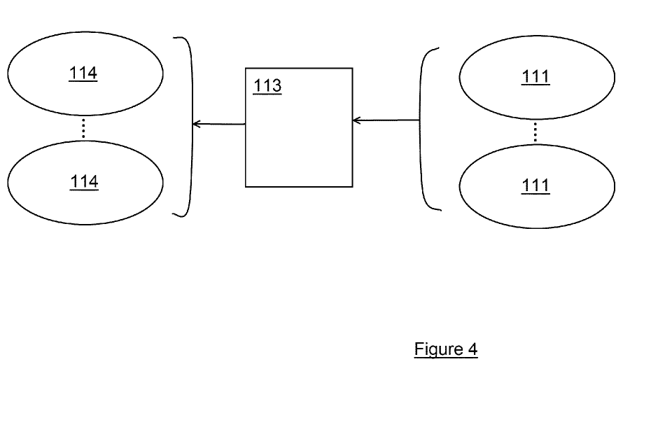

FIG. 4 shows a schematic diagram of part of an embodiment; and

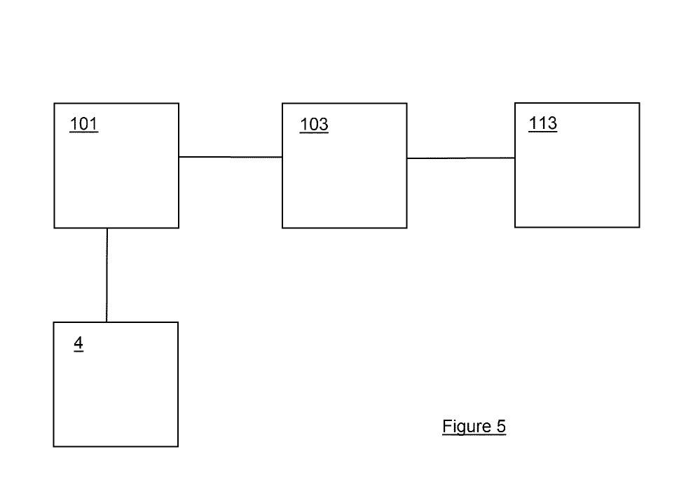

FIG. 5 shows a schematic diagram of an embodiment.

According to some embodiments, and with reference to FIG. 1 for example, a server 1 is provided which may be configured to be communicatively coupled to a user computing device 2. The communicative coupling many be over a network which may include the internet 5.

The server 1 includes a query receipt module 101 (see FIG. 2) which is configured to receive a search query 102 or a part of a search query 102. The search query 102 (or part thereof) may be received from the user computing device 2 over the communicative coupling between the server 1 and the user computing device 2.

The query receipt module 101 may be configured to pass the search query 102 (or part thereof) to a term retrieval module 103. The term retrieval module 103 is configured to receive the search query 102 from the query receipt module 101 and to output an expanded search query 104.

The server 1 may further include an expanded query output module 105 which is configured to receive the expanded search query 104 from the term retrieval module 103.

The expanded query output module 105 may be communicatively coupled to a search engine module 106. The search engine module 106 may be provided by the server 1 or may be provided by a separate server 3 which is communicatively coupled to the server 1 (again, the communicative coupling may be over a computer network which may include the internet 5).

In some embodiments, the search engine module 106 is configured to provide a search engine interface 107 which may be displayed on the user computing device 2 (in embodiments in which the search engine module 106 is provided on the separate server 3, the separate server 3 may be communicatively coupled to the user computing device 2 (e.g. over a computer network such as the internet 5)).

In some embodiments, the search query 102 is input by the user into the search engine interface 107 which may provide an input field for the user to input the search query 102. The search engine interface 107 and/or the search engine module 106 may pass the search query 102 to the query receipt module 101 (in some embodiments, the query receipt module 101 will intercept the search query 102 from the search engine interface 107). The phantom line in FIG. 2 between the search engine interface 107 and the search query 102 which is received by the query receipt module 101 illustrates these possible relationships. In some embodiments, the search engine interface 107 is provided by the query receipt module 101 rather than the search engine module 106.

The search engine module 106 may be communicatively coupled to a retrieval module 108 which may, in turn, be communicatively coupled to an index module 109. The retrieval module 108 and/or the index module 109 may be provided by the server 1 or the separate server 3. The search engine module 106 may be configured to receive the search query 102 or the expanded search query 104 and to generate a retrieval query 110. The search engine module 106 is configured to send the retrieval query 110 to the retrieval module 108 which is configured to receive the retrieval query 110.

The retrieval module 108 is configured, on receipt of the retrieval query 110, to access the index module 109 and retrieve one or more identifiers for one or more information resources 111 based on the retrieval query 110. For example, the retrieval query 110 may include one or more search terms which are compared to one or more entries in an index of the index module 109 each entry being associated with one or more information resources 111. There may, in some embodiments, be more than one entry associated with each information resource 111. Each entry may include one or more terms (such as a word or phrase).

The retrieval module 108 may be further configured to output the one or more retrieved identifiers, and/or the or each information resource 111 to which those one or more identifiers relate, to a results output module 115. The one or more retrieved identifiers and/or the or each information resource 111 to which those one or more identifiers relate are search results 116. The results output module 115 may, therefore, be communicatively coupled to the retrieval module 108. The results output module 115 may be configured to display (or otherwise present) the search results 116, which may be via the user computing device 2 and/or via the search engine module 106 and/or via the query receipt module 101 and/or via the search engine interface 107.

Thus, in accordance with embodiments, a system 1000 comprising a number of modules 101,103,105,106,108,109,115 is provided which is configured to receive a search query 102 and output search results 116 in response to the search query 102.

In some embodiments (see FIG. 3), an index generation module 112 is provided which is configured to generate the index of the index module 109. The index generation module 112 may be provided by the server 1 or the separate server 3. The index generation module 112 may, in some embodiments, form part of the system 1000.

The index generation module 112 is configured to receive one or more information resources 111 and to generate entries in the index based on the content of the or each information resource 111. For example, the index generation module 112 may be configured to analyse the or each information resource 111 and to extract one or more keywords or keyphrases (i.e. terms) which represent the content of the or each information resource 111.

The or each information resource 111 may comprise a document (such as a webpage). The or each information resource 111 may be an information resource 111 which is available to the user computing device 2—e.g. because the information resource 111 is stored on the computing device 2 or because it is accessible over a communication link (such as a computer network which may include the internet 5). In some embodiments, the or each information resource 111 is available to the user computing device 2 only on payment of a fee—in which case, the results output module 115 may be configured to process payment of the fee based on payment information provided by the user (e.g. via the user computing device 2) to provide access to the information resource 111 on request of a user (that information resource 111 or an identifier for the information resource 111 may have been part of the search results 116, for example).

In some embodiments (see FIG. 4), a classification module 113 is provided (which may, in some embodiments be part of the system 1000). The classification module 113 is configured to receive one or more information resources 111 which may each be viewed as seed information resources 111. On receipt of an information resource 111 by the classification module 113, the classification module 113 may be configured to analyse the information resource 111 to use a probabilistic distribution of the terms (i.e. words and/or phrases) in the information resource 111 to provide a substantially unique signature for that information resource 111. Information resources 111 that have common linguist characteristics—for example, they use the same variant of a language—are grouped and the signatures for those information resources may be combined to form a language model 114.

There may be multiple language models 114 which may each represent a different language and/or a different variant of a language.

For each new information resource 111 which is analysed by the classification module 113, the associated substantially unique signature may be compared to the or each language model 114. If the signature is sufficiently close to a language model 114, then the information resource 111 is determined to be associated with that language model 114 (and the language variant represented by that language model 114). The signature may, in some embodiments, be combined with that language model 114 to update the language model 114.

In some embodiments, the comparison of the substantially unique signature for an information resource 111 with a language model 114 is achieved by the classification module 113 using entropies. In particular, the classification model 113 may assume that the information resource 111 is equivalent to a noisy communication channel in that a sequences of terms, W, is generated by an information resource creator with a probability p(W) and transmitted through a noisy communication channel to provide the observation, A, (the information resource 111) with the probability p(A|W).

Accordingly, the entropy, H, of an information resource 111 may be computed using the average of the log probability of terms for the information resource 111 by the classification module 113 using:

$$H = {lim}_{n -> ∞} \frac{1}{k} {\sum }_{k}^{ } p ( x ) {log}_{2} p ( x )$$

$$or simply$$

$$H \approx - \frac{1}{n} {log}_{2} p ( x )$$

where p is the probability distribution of a segment of text x of k words.

The information resource entropy, therefore, forms the substantially unique signature for the language or language variant of the information resource 111.

The substantially unique signature (i.e. the information resource entropy) for a new information resource 111 (i.e. an information resource 111 not used in the generation of the signature for a language or language variant) may be compared to a plurality of the language models 114 (each representing a language or language variant) to provide an indication of the likely language or language variant of that new information resource 111.

In some embodiments, perplexities rather than entropies are used: perplexity being 2^{H(x)}.

In some embodiments, the signature (i.e. entropies) for the new information resource 111 is added to the closest of the language models 114 to update the language model 114. In some instances, the addition of a new signature may include the removal of a signature—which may be the oldest signature forming part of the language model 114, for example.

Thus, the substantially unique signatures forming the language models 114 and representing languages or language variants may be continually or periodically updated.

In some embodiments, the classification module 113 is further configured to perform a clustering operation. The clustering operation compares the substantially unique signatures and/or the language models 114 which the classification module 113 has generated in order to determine whether or not it is possible to cluster any of the language models 114 together. Clustering may involve the association of similar language models 114 with an indication that the clustered language models 114 relate to similar languages or language variants. In some embodiments, however, clustering may include the combining of language variants which are similar by merging the associated language models 114.

If the clustering process produces fewer clusters of language models 114 than there are recorded languages or language variants which the classification module 113 is configured to handle, then the classification module 113 may be configured to generate one or more new language models 114—each new language model 114 being generated by merging two or more of the closest language models determined by the clustering process.

Thus, in embodiments, the classification module 113 generates a plurality of language models 114 (by the above methods or otherwise) which represent a corresponding plurality of languages and/or language variants.

A language variant may, for example, be a regional dialect of a language (there may be multiple regional dialects of the language and each may be a language variant). For example, there are many regional dialects of Arabic and each regional dialect may be a language variant represented by a language model 114. In another example, British English and American English each form a respective language variant.

In some embodiments, a language variant may be determined by the educational or cultural background of the creator of the information resource 111 rather than by geography. Thus, for example, an engineer and a scientist may use different terms to describe similar concepts.

The classification module 113 may store the or each language model 114 or may have access to a remote store of the or each language model 114. The or each language model 114 may be stored on the server 1 or separate server 3, for example.

The term retrieval module 103 may be communicatively coupled to the classification module 113. The term retrieval module 103 may be configured to send a received search query 102 to the classification module 113. The classification module 113 may, in turn, be configured to receive the search query 102 from the term retrieval module 103. On receipt of the search query 102, the classification module 113 may be configured to determine one or more terms for addition to the search query 102 (the one or more terms for addition being related to one or more terms of the search query 102).

The relationship may, for example, be a synonymous term in a different language or language variant.

The one or more terms for addition to the search query 102 may be determined by using the or each language model 114 and/or the one or more information resources 111 which were used in the generation of the or each language model 114. Thus, a search query 102 including the term “stove” may result in the classification module 113 generating an additional term “cooker” (“stove” in American English being generally synonymous with the term “cooker” in English).

For example, semantic information may be extracted from the information resources 111 to determine terms which are related to one or more terms of the search query 102 (this may have been done during generation of the language models 114). This semantic information may be derived from the information resources 111 by analysis of the contextual content of the terms in the information resources 111.

In some embodiments, the relationship may, for example, be a term which is commonly used in conjunction or association with the or each term of the search query 102. For example, a search query 102 including the term “cooker” may be commonly used in conjunction with terms such as “electric”, “gas”, “induction”, and the like.

The classification module 113 may be configured to receive an IP address associated with the user submitting the search query 102 as part of the search query 102. The classification module 113 may use the IP address in order to determine a likely geographical location of the user and, hence, a likely language or language variant used in the generation of at least part of the search query 102 by the user.

In some embodiments, the search query 102 includes other information which allows the classification module 113 to determine a likely language or language variant used in at least part of the search query 102. For example, the other information may include a user identifier (the classification module 113 may have access to a database which associates user identifiers with a language or language variant of the user, that database may be part of the classification module 113 or may be separate therefrom). In an example, the other information may include information harvested from or by an interface program (e.g. a web browser) which may provide an indication of the language or language variant of the user (this may include one or more cookies, for example).

In some embodiments, the search query 102 is analysed by the classification module 113 to determine a likely language or language variant of the search query 102 based on its content.

In some embodiments, a combination of such techniques is used.

Accordingly, the classification module 113 may be configured to determine a language or language variant used by the user in generating at least part of the search query 102. The classification module 113 may, therefore, use this information to identify the language model 114 (for example) of at least part of the search query 102. The classification module 113 may use this information to determine a likely intended meaning for at least part of the search query 102. The classification module 113 may then use this likely intended meaning in the generation of the expanded search query 104 by selecting appropriate synonymous terms from other languages or language variants or by selecting terms which are used in conjunction or association with one or more terms of the search query 102 in that language or language variant.

The classification module 113 may be configured to output the expanded search query 104 in response to the receipt of the search query 102. The term retrieval module 103 may, therefore, be configured to receive the expanded search query 104 and to send the expanded search query 104 to the search engine module 106 via the expanded query output module 105.

In some embodiments, the search engine module 106 processes the expanded search query 104 into the retrieval query 110 for transmission to the retrieval module 108. The retrieval query 110 may include other information (in addition to that of the expanded search query 104) which has been generated by the search engine module 106. This other information may include information to assist in the generation of search results 116 or may be tracking or user information.

In some embodiments, the search engine module 106 is provided by a third party who does not provide the classification module 113. In some embodiments, the search engine module 106 a conventional search engine which is substantially unaware of the modification of the search query 102 into the expanded search query 104.

In some embodiments, the search engine module 106 is configured to output a retrieval query 110 which includes an indication of a subset of information resources 111 on which the search is to be based (this indication may be an indication of a part of the index of the index module 109). That indication may be provided as part of the expanded search query 104 by the classification module 113. The part of the index may be a part which is associated with the language or language variant determined by the classification module 113 to be the language or language variant of at least part of the search query 102.

Thus, in some embodiments, the retrieval module 108 may access a part of the index of the index module 109 based on the content of the retrieval query 110. That part may, for example, be based on the above indication within the retrieval query 110.

In some embodiments, the other information in the retrieval query 110 includes indications of different parts of the index of the index module 109 which are to be used in relation to different parts of the expanded search query 104. For example, the expanded search query 104 may comprise one or more terms from the original search query 102 in a first language or language variant and one or more further terms added by the classification module 113 in a second language or language variant. Thus, the other information may include indications that a part of the index associated with information resources 111 in the first language or language variant is to be searched using the one or more terms from the original search query 102 and that a part of the index associated with information resources 111 in the second language or language variant is to be searched using the one or more terms added by the classification module 114. Of course, there may be more than two different languages and language variants used with a corresponding number of part of the index. The other information may be provided by the classification module 113 and/or the search engine module 106.

In some embodiments, the modules described herein a combined. Thus, for example, the term retrieval module 103 may be combined with the classification module 113. The expanded query output module 105 may also (or alternatively) be combined with the term retrieval module 103. The search engine module 106 may be combined with the term retrieval module 103. The index module 106 may be combined with the retrieval module 108, as might the results output module 115. The classification module 113 may be combined with the index module 109—which may allow the index to be categorised in accordance with the language or language variants identified by the classification module 113. Indeed, all of the modules 101,103,105,106,108,109,112,115,113 may be combined in some embodiments.

As will be appreciated, therefore, embodiments of the present invention may include modules, such as the query receipt module 101, term retrieval module 103, classification module 113, and expanded term output module 105 which can be communicatively coupled to a search engine module 106, retrieval module 108, index module 109, and results output module 115, which are all independently provided. Indeed, the search engine module 106 may be configured to receive and act on the search query 102 in some embodiments in another mode of operation. Thus, in some embodiments, the query retrieval module 101 may be viewed as intercepting the search query 102 and providing a degree of pre-processing of the search query 102 with a view to improving the search results 116. However, in some embodiments, all of the modules form an integrated system in which the search engine module 106 is configured such that it is prevented from receiving the search query 102 directly (e.g. by providing no interface 107 for a user to input the search query 102 directly into the search engine module 106).

In some embodiments, the classification module 113 is further configured to cause a plurality of options to be presented to a user (e.g. via the user computing device 2 and via the interface 107 in some embodiments). The options may include a user selectable list of languages and/or language variants. The user may select the language or language variant of the search query 102. The list may be a subset of the languages and/or language variants of which the classification module 113 is aware. That subset may be determined by an analysis of the search query 102 by the classification module 113 to determine the likely language or language variant of the search query 102. Such analysis may be similar to the analysis described above.

In some embodiments, the options may additionally or alternatively include a plurality of terms. In some embodiments, there are a multiple groups of options each comprising a plurality of terms and a term from each group of options may be selected by the user (through an interface such as the search engine interface 107, for example). Each group may represent terms associated with the one or more terms of the search query 102 from a respective plurality of the languages or language variants of which the classification module 113 is aware (i.e. for which the classification module 113 has access to a language model 114).

The selected options may, therefore, form part of the search query 102 or expanded search query 104. The selected options may indeed, therefore, comprise the one or more terms which are added to the search query 102 to form the expanded search query 104.

As will be appreciated, embodiments of the present invention seek to provide better search results 116 for a given search query 102. This may be achieved through the use of language models to identify synonyms and/or, in some embodiments, this may be achieved by providing related search terms using semantic information associated with the language or language variant of the search query 102. In some embodiments, the search is limited to information resources 111 which share a common language or language variant with the search query 102 but in other embodiments, the search is not so limited. In some embodiments, several limited searches are performed: each search being based on a synonym of a term of the search query 102 but limited to information resources 111 which use that synonym in their language or language variant in an appropriate manner.

The information resources 111 may include, for example, information resources which are available via the internet (or some other network 5)—such as webpages. The information resources 111 may include books.

In other embodiments, the search query 102 is, in fact, a query generated by a translation module 4 which is configured to perform a translation of an information resource 111. The search query 102 may include the whole or a part of the information resource 111 and may include a translation of the whole or part of the information resource 111 into a first language or language variant. The classification module 113 may be configured to determine a synonym in a different language or language variant for a term forming part of the search query 102 in such an embodiment. The classification module 113 may return the synonym to the translation module 4. Thus, some embodiments seek to provide a more accurate translation service (which may be a machine translation service). The translation service may provide a translation which is specifically tailored for a language or language variant (i.e. specifically tailored to adopt the correct term from the target language or language variant). Thus, for example, the classification module 113 may provide the contextually translation of a term into another language or language variant based on the language or language variant of the search query 102 (i.e. the original information resource 111 being translated). In embodiments, one language variant is translated into another variant of the same language. For example, to translate “The president had a lunch with the Saudi king” into French the translation module may output “Le président a eu un déjeuner avec le roi d'Arabie Saoudite” for French readers and “Le président a eu un dîner avec le roi d'Arabie Saoudite” for Canadian readers. In such embodiments, the search engine module 106 and other associated modules may be omitted from the system 1000.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A system comprising:
a term retrieval module configured to receive a search query including a search term and to output an expanded search query including the search terms and an additional search terms; and
a search engine sub-system configured to receive the expanded search query and to output one or more search results based on the expanded search query, the one or more search results indicating one or more information resources of relevance to the expanded search query, wherein the system further comprises:
a classification module configured to determine a language or language variant of the search term of the search query, identify the additional search term based on the language or language variant of the search term, and output the additional search term to the term retrieval module.

2. A system according to claim 1, wherein the classification module is configured to identify the additional search term from a term which is semantically related to the search term within the context of the language or language variant of the search term.

3. A system according to claim 1, wherein the classification module is configured to identify the additional search term from a term which is semantically related to the search term within the context of the language or language variant of the search term; and
wherein the search engine sub-system is configured to output one or more search results indicating one or more information resources of relevance to the expanded search query, the information resources being in a language or language variant of the search term.

4. A system according to claim 1, wherein the search engine sub-system comprises:
a search engine module configured to receive the expanded search query;
an index module including an index of information resources; and
a retrieval module communicatively coupled to the search engine module and the index module and operable to access at least a portion of the index of the index module to identify one or more search results.

5. A system according to claim 1, wherein the search engine sub-system comprises:
a search engine module configured to receive the expanded search query;
an index module including an index of information resources; and
a retrieval module communicatively coupled to the search engine module and the index module and operable to access at least a portion of the index of the index module to identify one or more search results and access at least a portion of the index based on the language or language variant of the search term.

6. A system according to claim 1, wherein the classification module is configured to identify the additional search term from a term which is synonymous with the search term in a language or language variant different to the language or language variant of the search term.

7. A system according to claim 1, wherein the classification module is configured to identify the additional search term from a term which is synonymous with the search term in a language or language variant different to the language or language variant of the search term;
wherein the search engine sub-system comprises:
a search engine module configured to receive the expanded search query;
an index module including an index of information resources; and
a retrieval module communicatively coupled to the search engine module and the index module and operable to access at least a portion of the index of the index module to identify one or more search results, the portion of the index being determined by the language or language variant of the search term and the language or language variant of the additional search term.

8. A system according to claim 1, further comprising an index generation module which is configured to generate an index of information resources for use in determining the one or more search results, wherein the index generation module is coupled to the classification module such that the index generation module is further configured to classify the index based on a language or language variant of each information resource determined by the classification module.

9. A system according to claim 1, further comprising a module to present an interface to a user, wherein the interface is configured to present one or more user selectable options for the language or language variant of at least one of the search query and the additional search term.

10. A system according to claim 1, further comprising a module to present an interface to a user, wherein the interface is configured to present one or more user selectable options for the language or language variant of at least one of the search query and the additional search term and wherein the user selectable option for the additional search term comprises a plurality of possible additional search terms identified by the classification module and the language or language variants include regional language variants.

11-13. (canceled)

14. A computer implemented method comprising:
receiving a search query including a search term at a term retrieval module;
outputting, from the term retrieval module, an expanded search query including the search terms and an additional search terms;
receiving the expanded search query at a search engine sub-system;
outputting, from the search engine sub-system, one or more search results based on the expanded search query, the one or more search results indicating one or more information resources of relevance to the expanded search query; and
determining, using a classification module, a language or language variant of the search term of the search query, identifying the additional search term based on the language or language variant of the search term, and outputting the additional search term to the term retrieval module.

15. A method according to claim 14, further comprising:
identifying, using the classification module, the additional search term from a term which is semantically related to the search term within the context of the language or language variant of the search term.

16. A method according to claim 14, wherein the outputting one or more search results indicating one or more information resources of relevance to the expanded search query, comprises outputting search results indicating one or more information resources in a language or language variant of the search term.

17. A method according to claim 14, further comprising:
identifying, using the classification module, the additional search term from a term which is semantically related to the search term within the context of the language or language variant of the search term;
receiving the expanded search query in a search engine module;
providing an index module including an index of information resources;
providing a retrieval module communicatively coupled to the search engine module and the index module; and
accessing at least a portion of the index of the index module to identify one or more search results; and
wherein the outputting one or more search results indicating one or more information resources of relevance to the expanded search query, comprises outputting search results indicating one or more information resources in a language or language variant of the search term.

18. A method according to claim 14, further comprising:
identifying, using the classification module, the additional search term from a term which is semantically related to the search term within the context of the language or language variant of the search term;
receiving the expanded search query in a search engine module;
providing an index module including an index of information resources;
providing a retrieval module communicatively coupled to the search engine module and the index module; and
accessing at least a portion of the index of the index module to identify one or more search results;
wherein the outputting one or more search results indicating one or more information resources of relevance to the expanded search query, comprises outputting search results indicating one or more information resources in a language or language variant of the search term; and
wherein accessing at least a portion of the index is based on the language or language variant of the search term.

19. A method according to claim 14, further comprising:
identifying, using the classification module, the additional search term from a term which is synonymous with the search term in a language or language variant different to the language or language variant of the search term.

20. A method according to claim 14, further comprising:
identifying, using the classification module, the additional search term from a term which is synonymous with the search term in a language or language variant different to the language or language variant of the search term;
receiving the expanded search query in a search engine module;
providing an index module including an index of information resources;
providing a retrieval module communicatively coupled to the search engine module and the index module; and
accessing at least a portion of the index of the index module to identify one or more search results, the portion of the index being determined by the language or language variant of the search term and the language or language variant of the additional search term.

21. A method according to claim 14, further comprising:
generating, in an index generation module, an index of information resources for use in determining the one or more search results, wherein the index generation module is coupled to the classification module; and
classifying, using the index generation module, the index based on a language or language variant of each information resource determined by the classification module.

22. A method according to claim 14, further comprising:
presenting an interface to a user, wherein the interface is configured to present one or more user selectable options for the language or language variant of at least one of the search query and the additional search term.

23. A method according to claim 14, further comprising:
presenting an interface to a user, wherein the interface is configured to present one or more user selectable options for the language or language variant of at least one of the search query and the additional search term;
wherein the user selectable option for the additional search term comprises a plurality of possible additional search terms identified by the classification module; and wherein the language or language variants include regional language variants.

24-29. (canceled)
